(19) United States
(12) Patent Application Publication
(10) Pub. No.: US 2008/0168645 A1
(43) Pub. Date: Jul. 17, 2008

(54) Composite polymeric material, and method and system for making the same

(76) Inventor: Joe C. Grasty, Long Beach, CA (US)

Correspondence Address: FITZPATRICK CELLA HARPER & SCINTO, 30 ROCKEFELLER PLAZA, NEW YORK, NY, 10112, US

(21) Appl. No.: 11/652,677

(22) Filed: Jan. 12, 2007

(51) Int. Cl. B32B 9/00

(52) U.S. Cl. 29/428; 425/472; 428/411.1

(57) ABSTRACT

A composite material includes individual layers each having a plurality of bands of polymeric tape disposed generally parallel to each other. At least one polymeric fiber is provided between adjacent bands of the polymeric tape. A matrix at least partially covers the bands of tape and the fiber. Together, the plurality of bands, the polymeric fiber, and the matrix form a single layer composite material, which can be further processed.

### BACKGROUND OF THE INVENTION

The present invention relates to a composite material, a process for making the composite material, and a system for making the composite material. More particularly, the present invention relates to a composite material made from a plurality of bands of polymeric tape, polymeric fibers, and a thermoplastic matrix.

Polymeric tapes are readily available in the marketplace from a variety of manufacturers. The properties of the polymeric material forming the tapes make them desirable for use in the manufacture of many different articles. As one example, a polymeric tape made from ultra high molecular weight polyethylene is of sufficient strength for potential use in the making of components of ballistic resistant armor. In order to be used in such an application, however, polymeric tape of significant size is required.

Most manufactured polymeric tapes are only available in limited sizes, which are generally small in width. Thus, in order to form a larger width structural material from the polymeric tape, several bands or strips of tape would need to be connected together. The edges of the tape, however, may not be exactly straight, and thus, two bands of tape placed side by side may not evenly match. Any composite material made from a plurality of bands of such tape could thereby have a significant gap formed where the edges of two adjacent bands are not straight and do not flushly align. In order to effectively avoid such gaps, adjacent bands of tape can be overlapped. However, such overlapping in the composite material would result in a welt of increased thickness in areas where edges of the bands of tape overlap. These gaps and welts prevent the composite structure formed from the plurality of bands of tape from being useful in many applications.

What is needed, therefore, is a satisfactory composite material that comprises a plurality of bands of polymeric tape, as well as a method and system for making such a composite material.

### SUMMARY OF THE PREFERRED EMBODIMENTS

The present invention can provide a composite article made from a plurality of bands of polymeric tape. It can also provide a method for making a composite article from a plurality of bands of polymeric tape, and can provide a system for making a composite article from a plurality of bands of polymeric tape.

In one embodiment of the invention, a composite material comprising a plurality of bands of polymeric tape is disclosed. At least one polymeric fiber is provided in a space between the bands of polymeric tape. A matrix at least partially covers the bands of tape and the fiber to form a single layer structure. The plurality of bands of polymeric tape may be made from an ultra high molecular weight polyethylene, and the fiber may also be made from an ultra high molecular weight polyethylene. The composite material may further comprise 1 to 10 polymeric fibers per junction, and the plurality of bands of tape may each be about 1.5 inches wide. The matrix material may be a thermoplastic or thermoset.

In another embodiment of the invention, a method for making a composite material is disclosed. The method includes the steps of providing a plurality of bands of a polymeric tape arranged with a space between each band, and further providing at least one polymeric fiber. The method further includes the steps placing at least one polymeric fiber in the space between the bands of polymeric tape, and covering the bands of polymeric tape and the polymeric fiber or fibers with a matrix so as to form a single layer structure. In a further embodiment, a plurality of layers of composite material may be made, with the layers cross-plied at an angle to each other to thereby form a ballistic resistant laminate structure.

In yet another embodiment of the invention, a system for making a composite material is disclosed. The system includes means for supplying a plurality of bands of polymeric tape and means for supplying at least one polymeric fiber. The system further comprises means for aligning the polymeric fiber in a space between the bands of polymeric tape, and means for at least partially covering the bands polymeric tape and the polymeric fiber or fibers with a matrix.

### BRIEF DESCRIPTION OF THE DRAWINGS

FIG. 1 is a view of the inventive system performing the initial processing step of the composite article forming process.

FIG. 2 is another step of the composite article forming process being performed by the system.

FIG. 3 shows the system performing another step of an article forming process using the composite article.

FIG. 4 is a view of the system performing an initial processing step of an alternative embodiment of the invention.

### DETAILED DESCRIPTION OF THE PREFERRED EMBODIMENTS

More specific features of the invention will now be described in conjunction with the drawings. It should be noted that while specific forms of the features of the invention are shown, one of ordinary skill in the art may recognize readily applicable alternatives for many of the features.

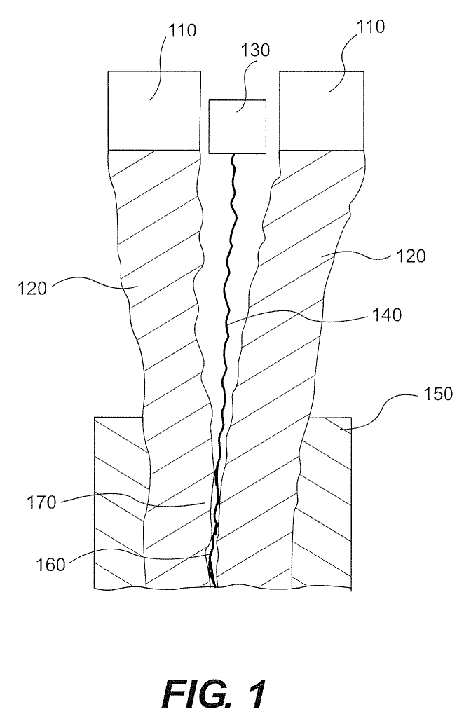

FIG. 1 shows a system performing the initial processing step for making the composite article comprising two bands of polymeric tape 120 and a polymeric fiber 140. In this step, two sources 110 provide two bands of polymeric tape 120. Another source 130 provides a polymeric fiber 140. These sources may be, for example, spools or rolls of the polymeric tape and polymeric fiber materials. The sources are made to feed the materials using techniques known in the art. Note, although the source 130 of the polymeric fiber is shown to be disposed between the two sources of tape in FIG. 1, other arrangements are possible. For example, the source 130 of the polymeric fiber 140 may be placed above, below, in front of, or behind the sources 110 of polymeric tape 120. Also, as further described below, additional sources of tape and fibers may be used in order to form a composite article with more than two bands of tape and one fiber.

The polymeric tape and the polymeric fibers may or may not have a similar chemical composition. In some embodiments of the invention, the individual bands of polymeric tape may be formed of materials different from each other. Similarly, when a plurality of polymeric fibers are used, the fibers may be formed of differing materials.

In an embodiment, the polymeric tape 120 may be made from an ultra high molecular weight polyethylene material. As an example, tape sold under the trademark TENSYLON may be used in this embodiment of the invention. The polymeric fiber 130 may also be made from ultra high molecular weight polyethylene, although not necessarily the same ultra high molecular weight polyethylene material as the polymeric tape. As an example, fibers sold under the trademark DYNEEMA may be used in an embodiment of the invention. TENSYLON tape and DYNEEMA fibers are structurally strong, and therefore allow for the formation of a strong composite material according to the invention.

In one embodiment of the invention, a polymeric tape having a width from about 0.1 to 12 inches may be used. In one particular embodiment, the bands of polymeric tape may have a width of 1.5 inches. In some embodiments, 12 micron diameter fibers can be used. It should also be noted that the individual bands of polymeric tape may have sizes differing from each other. For example, one of the bands of polymeric tape 120 in FIG. 1 could have a width greater than that of the other band of tape. Similarly, when multiple polymeric fibers are used in a particular composite material, the polymeric fibers can be of different sizes.

The bands of polymeric tape 120 and polymeric fiber 140 supplied from the sources 110 and 130 are brought into an initial arrangement using unshown feeding and guiding elements. For example, rollers may be used to move and align the tape and/or fibers. As another example, eyelet type devices may be used to guide the materials into an initial alignment.

As further shown in FIG. 1, the polymeric tape 120 and polymeric fiber 140 are then placed in a unidirectional manner on a lay-up surface 150. In the arrangement, the polymeric fiber 140 is arranged between the two spaced bands of polymeric tape 120 such that at least parts of edges 160 of the fiber abut or nearly abut edges 170 of the polymeric tape 120. The polymeric fiber 140 can thereby compensate for any irregularities that may be present in the edges 170 of the bands of the polymeric tape 120. For example, each edge of TENYSLON tape, discussed above, can have irregularities that vary up to approximately ±5 percent of the width of the tape. Thus, the edges of two adjacent bands of TENYSLON tape will not flushy align in many places. Instead gaps will be formed at some locations between adjacent bands of tape. Gaps weaken the composite article ultimately manufactured. In the present invention, however, the polymeric fiber or fibers eliminate the gaps between the uneven edges of bands of polymeric tape by filling substantially the entire void between spaced bands of the tape. In essence, the polymeric fibers spread out to fill most, if not all, of the space between the bands of tape.

As an example, DYNEEMA fibers, used in some embodiments of the invention, are actually made of micro-fibers. A large amount of void space is present between the micro-fibers, which allows for compression of the overall DYNEEMA fiber structure. Thus, according to the inventive process, a DYNEEMA fiber having a thickness greater than the polymeric tape may initially be arranged between adjacent bands of tape. The DYNEEMA structure can then be compressed down under pressure to fill almost the entire space between adjacent bands of tape. Such compression can take place during placement of the DYNEEMA fibers, or after such placement in the subsequent matrix application step, discussed below.

The fiber or fibers thereby allow for the formation of a composite material with a plurality of bands of tape which is substantially gap free by bridging uneven edges of the bands of tape. The fiber or fibers also eliminate the possibility of forming welts in the composite material as the bands of tape may be spaced apart such that there is no overlap between the edges of the bands of tape. At the same time, fibers maintain the desired structural properties in the spaces between the bands of tape. Thus, a strong, uniformly thick composite article may ultimately be produced.

FIG. 1 demonstrates the processing step as being carried out in a continuous manner. The sources 110 provide continuous bands of polymeric tape 120, and the source 130 provides a continuous polymeric fiber 140. As an alternative, the process could be carried out in a batch-mode manner, wherein the sources 120 and 130 provide segmented bands of polymeric tape and segmented polymeric fibers of a desired length.

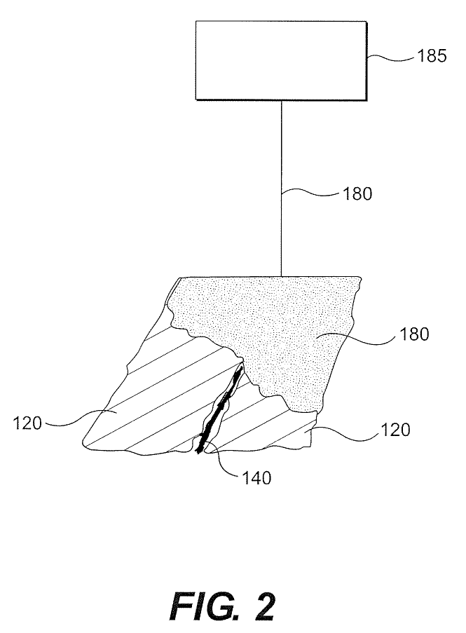

A further step of making the composite article is shown in FIG. 2. In this step, the arranged bands of polymeric tape 120 and polymeric fiber 140 are covered with a matrix 180 supplied from a matrix source 185. The matrix 180, for example, may be a liquid thermoset, thermoplastic or elastomeric matrix that has been in-line or separately processed into a supported or unsupported web and is subsequently mated to the fibers. In some embodiments, enough matrix is added to form a product that is ultimately 8-12 percent by weight matrix material.

After the matrix 180 at least partially covers a portion of each band of polymeric tape 120 and a portion of the polymeric fiber 140, the matrix acts to bond the tape and fibers. A single layer composite material comprising the plurality of bands of polymeric tape, the polymeric fiber, and a thermoplastic matrix is thereby formed.

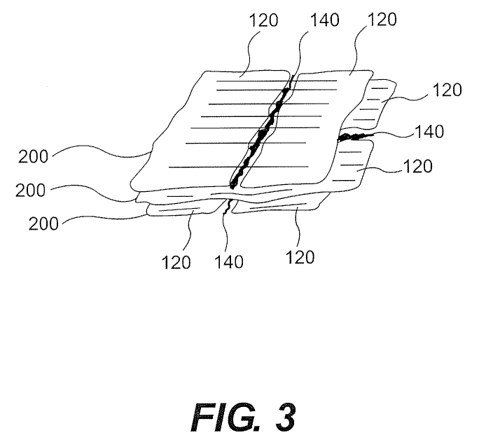

The formed single layer composite article can be a preimpregnated web, or “prepreg,” for further processing into a desired article. FIG. 3 shows an example of such a further processing step. A plurality of layers 200 of the composite laminate material are formed. The layers 200 used in forming the composite article may include a uniaxial prepreg fabric with a plurality of bands of polymeric tape, a polymeric fiber, and a thermoplastic or thermoset matrix made according to the processing steps described above. Alternatively, some of the layers 200 can be made by other processes known in the art, and thereby include different materials. In the particular step shown in FIG. 3, the layers 200 are cross-plied such that the bands of polymeric tape 120 and the polymeric fiber 140 of each layer 200 are cross-plied at an angle and bonded together onto the bands of polymeric tape and polymeric fiber of an adjacent layer. In some embodiments, the angle between the layers may be 90 degrees, while in other embodiments the angle may be less than 90 degrees. The multiple layers are then bonded in a manner known in the art, such as with heat and pressure, to form a multi-layered laminate article. In some embodiments, the bonded layers may be used to form a ballistic resistant laminate structure.

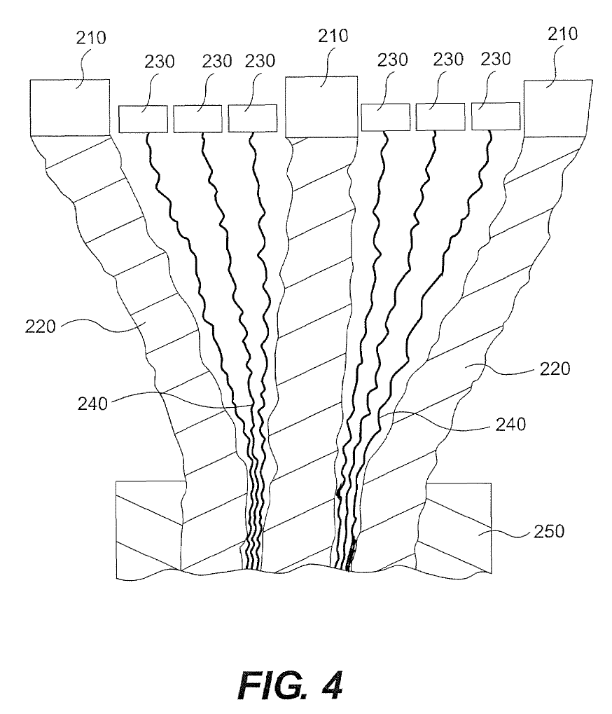

FIG. 4 shows an initial processing step of an alternative embodiment of the invention. In this embodiment, three sources 210 of polymeric tape 220 are provided. Further, six sources 230 of polymeric fibers 240 are provided. The arrangement is such that three polymeric fibers 240 are set between each of the bands of polymeric tape 240. Correspondingly, the formed composite material has three bands of polymeric tape 220, with three polymeric fibers 240 arranged between each of the bands.

FIG. 4 demonstrates the invention also encompasses using differing numbers of bands of polymeric tape and polymeric fibers. In particular embodiments, 1 to 10 fibers may placed between the bands of polymeric tape. In other embodiments, differing numbers of fibers may be placed between the bands of polymeric tape within each formed composite material. For example, three fibers may be placed between two bands of polymeric tape, and two fibers may be placed between two bands of polymeric tape, all within the same material being formed.

As described above, the polymeric tape used in the invention can be made from ultra high molecular weight polyethylene, such as TENSYLON tape, and the polymeric fibers can be made from ultra high molecular weight polyethylene, such as DYNEEMA fibers. A composite material formed with such a tape and fiber combination can be used in the manufacture of remarkably strong articles. As an example, a prepreg made according to the invention using TENSYLON tape and DYNEEMA fibers was pressed into free-standing sample panels. The free-standing panels comprised 310 composite layers. Each of the layers had 7 bands of TENSYLON tape, each band having a width of 1.5 inches. Eighteen DYNEEMA fibers of 1800 denier were used (3 fibers between adjacent bands of TENSYLON tape). These sample panels were tested and found to meet National Institute of Justice (NIJ) class III, IIIA, and lower ballistic threat standards. Based on these results, it is apparent that panels similar to those above in combination with a face or backing material, such as a ceramic or a metal, would produce superior NIJ class IV ballistic characteristics.

While the present invention has been described in conjunction with specific embodiments, it is evident that numerous alternatives, modifications, and variations will be apparent to those skilled in the art of the foregoing description. Accordingly, the present invention is not intended to be limited to the described embodiments, and should be interpreted to include all such alternatives, modifications, and variations.

1. A composite material, comprising:
a plurality of bands of polymeric tape disposed generally parallel to each other;
at least one polymeric fiber provided between said plurality of bands of polymeric tape; and
a matrix at least partially covering said bands of tape and said at least one fiber, wherein said plurality of bands, said at least one polymeric fiber, and said matrix form a single layer.

2. A composite material according to claim 1, wherein said plurality of bands of polymeric tape are made from ultra high molecular weight polyethylene.

3. A composite material according to claim 1, wherein said at least one polymeric fiber is made from ultra high molecular weight polyethylene.

4. A composite material according to claim 1, wherein said plurality of bands of polymeric tape are made from ultra high molecular weight polyethylene, and said at least one polymeric fiber is made from ultra high molecular weight polyethylene.

5. A composite material according to claim 1, wherein said plurality of bands of polymeric tape and said at least one polymeric fiber have a similar chemical composition.

6. A composite material according to claim 1, wherein said at least one fiber is formed from micro-fibers.

7. A composite material according to claim 1, wherein 1 to 10 polymeric fibers are disposed between each adjacent pair of said bands of polymeric tape.

8. A composite material according to claim 1, wherein said plurality of bands of tape are each about 1.5 inches wide.

9. A composite material according to claim 1, wherein said matrix is a thermoplastic.

10. A composite material according to claim 1, wherein said matrix is a thermoset.

11. A composite material according to claim 1, further comprising at least one additional layer bonded to said single layer, said at least one additional layer also comprising a plurality of bands of polymeric tape, at least one polymeric fiber, and a matrix.

12. A composite material according to claim 10, wherein said plurality of bands of polymeric tape and said at least one polymeric fiber of said at least one additional layer are cross-plied at an angle and bonded to said plurality of bands of polymeric tape and said at least one polymeric fiber of said single layer to form a ballistic resistant laminate structure.

13. A method for making a composite material, comprising:
providing a plurality of bands of a polymeric tape arranged parallel to one another;
providing at least one polymeric fiber;
placing the at least one polymeric fiber between adjacent edges of the bands of polymeric tape; and
at least partially covering the plurality of bands polymeric tape and the at least one polymeric fiber with a matrix so as to form a single layer structure.

14. A method according to claim 13, wherein the plurality of bands of polymeric tape are made from ultra high molecular weight polyethylene.

15. A method according to claim 13, wherein the at least one polymeric fiber is made from ultra high molecular weight polyethylene.

16. A method according to claim 13, wherein the plurality of bands of polymeric tape are made from ultra high molecular weight polyethylene, and the at least one polymeric fiber is made from the ultra high molecular weight polyethylene.

17. A method according to claim 13, wherein the matrix is a thermoplastic.

18. A method according to claim 13, wherein the matrix is a thermoset.

19. A method according to claim 13, wherein the at least one polymeric fiber comprises 1 to 10 fibers between each pair of adjacent bands.

20. A method according to claim 13, further including forming plural layers, and cross-plying the plural layers at an angle, and bonding the plural layers to form a ballistic resistant laminate structure.

21. A method according to claim 13, wherein the plurality of bands of tape and the at least one fiber are supplied in a continuous manner using continuous length bands of polymeric tape and a continuous length fiber.

22. A system for making a composite material, the system comprising:
means for supplying a plurality of bands of polymeric tape;
means for supplying at least one polymeric fiber;
means aligning the polymeric fiber between adjacent edges of the bands of polymeric tape; and
means for at least partially covering the plurality of bands polymeric tape and the at least one polymeric fiber with a matrix.
